(19) United States
(12) Patent Application Publication
(10) Pub. No.: US 2015/0202749 A1
(43) Pub. Date: Jul. 23, 2015

(54) TORQUE MULTIPLIER FOR A VEHICLE TRANSMISSION FLANGE NUT

(71) Applicant: Honda Motor Co., Ltd., Tokyo (JP)

(72) Inventors: Zachary Sanders, Leeds, AL (US); Joshua Gowens, Anniston, AL (US); Jason H. Robinson, Bowdon, GA (US); Andrew L. Hammit, Fruithurst, AL (US); Jerry L. Carpenter, Temple, GA (US); Etobia Bogan, Douglasville, GA (US)

(73) Assignee: Honda Motor Co., Ltd., Tokyo (JP)

(21) Appl. No.: 14/159,517

(22) Filed: Jan. 21, 2014

(51) Int. Cl. B25B 17/02; B25B 27/00; B25B 23/00

(52) U.S. Cl. CPC B25B 17/02; B25B 23/0007; B25B 27/0035

(57) ABSTRACT

A torque multiplier for applying a predetermined torque to a transmission flange nut of a vehicle engine includes a support member for mounting the torque multiplier directly to a transmission case of a vehicle engine. A gear train is secured to the body. A socket is operably connected to the gear train. The socket engages a transmission flange nut.

### BACKGROUND

With the advent of six-speed transmissions for vehicle engines, a transmission flange nut having higher torque requirements was required. This flange nut generally requires about 31.5 kgf·m of torque to properly load, for example, transmission bearings, whereas previous flange nuts for five-speed transmissions only required about 18 kgf·m of torque. Therefore, with the increased torque requirements for the flange nut of the six-speed transmission, there is a need to decrease the required applied torque to a level which approximates the required applied torque for the flange nut of the five-speed transmission. To this end, torque multipliers are well-known; however, these known torque multipliers are not suitable for applying the required torque to the six-speed transmission flange nut.

### BRIEF DESCRIPTION

In accordance with one aspect, a torque multiplier for applying a predetermined torque to a transmission flange nut of a vehicle engine comprises a support member for mounting the torque multiplier directly to a transmission case of a vehicle engine. A gear train is secured to the body. A socket is operably connected to the gear train. The socket engages a transmission flange nut.

In accordance with another aspect, a torque multiplier for applying a predetermined torque to a transmission flange nut of a vehicle engine comprises a support member including first and second legs for mounting the torque multiplier directly to a transmission case of a vehicle engine. A planetary gear train is secured to the support member. A socket is operably directly connected to an output of the planetary gear train. The socket engages a transmission flange nut.

In accordance with yet another aspect, a method of applying a predetermined torque to a transmission flange nut of a vehicle engine comprises mounting a torque multiplier directly to a transmission case of the vehicle engine. The torque multiplier includes a support member having an aperture, a planetary gear train secured in the aperture and having an input and an output, and a socket operably connected to the output of the planetary gear train. The method further comprises engaging the transmission flange nut with the socket; and applying torque to the input of the planetary gear train.

### BRIEF DESCRIPTION OF THE DRAWINGS

FIG. 1 is a partial schematic view of a flange nut provided on a transmission case of a vehicle engine.

FIG. 2 is a top plan view of an exemplary torque multiplier mounted on the transmission case of FIG. 1 and operably engaged to the flange nut.

FIG. 3 is a side view in partial cross-section of the exemplary torque multiplier of FIG. 2.

FIGS. 4 and 5 are side perspective views of the exemplary torque multiplier.

FIG. 6 is a partial schematic cross-sectional view of the exemplary torque multiplier, the cross-section being taken normal to a center axis of the torque multiplier.

FIG. 7 is a schematic cross-sectional view of the exemplary torque multiplier taken along line 7-7 of FIG. 6

### DETAILED DESCRIPTION

It should, of course, be understood that the description and drawings herein are merely illustrative and that various modifications and changes can be made in the structures disclosed without departing from the present disclosure. In general, the figures of the exemplary torque multiplier for a transmission flange nut are not to scale. It will also be appreciated that the various identified components of the exemplary torque multiplier for a transmission flange nut disclosed herein are merely terms of art that may vary from one manufacturer to another and should not be deemed to limit the present disclosure.

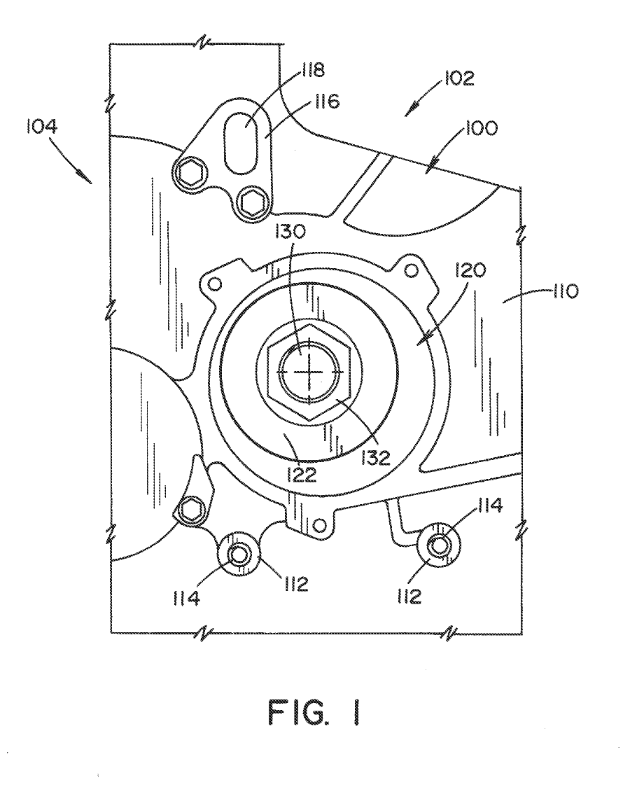

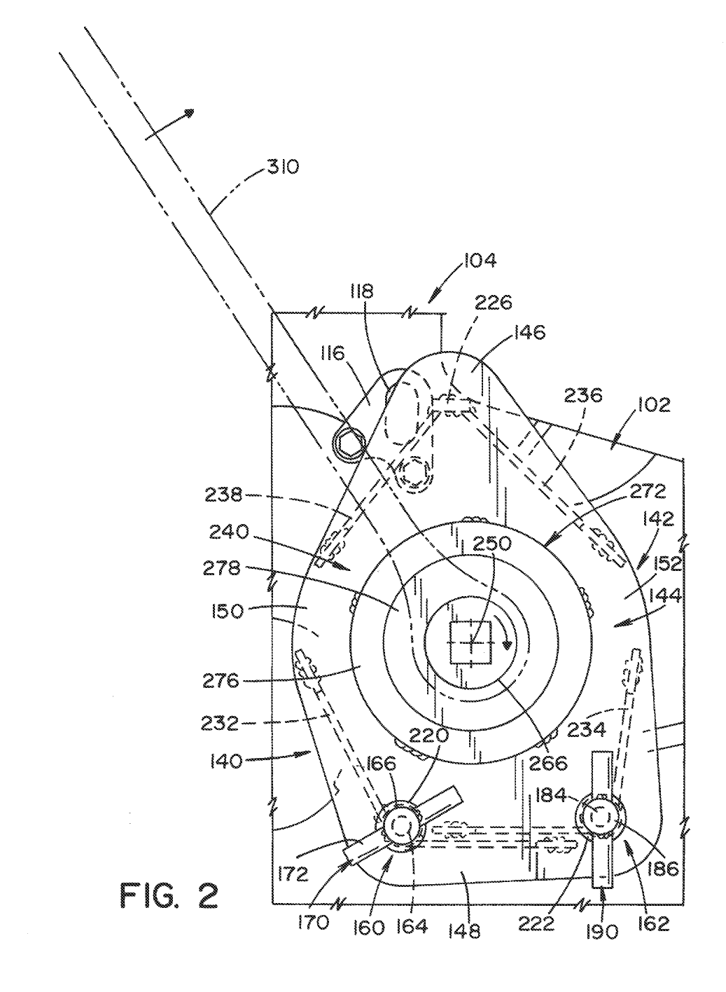

Referring now to the drawings, wherein like numerals refer to like parts throughout the several views, FIG. 1 schematically illustrates a portion 100 of a case or housing 102 of a transmission 104 of a vehicle engine (not shown). As is well known, a vehicle transmission typically delivers mechanical power from the engine to the remainder of a drive system, such as fixed final drive gearing, axles, and wheels. The transmission case 102 includes an outer wall 110 having attachment features, such as bolts 112 threaded in corresponding openings 114 provided in the outer wall 110 and a mounting bracket 116 secured to the outer wall and having an aperture 118. Further provided on the transmission case is a recessed portion 120 having a bottom wall 122 including an opening through which projects an end portion of a transmission shaft 130. A transmission flange nut 132 is secured to the end portion of the transmission shaft 130, which allows for a predetermined torque to be applied to the shaft 130 via the flange nut 132 to properly load, for example, transmission bearings. As indicated previously, with the advent of six-speed transmissions for vehicle engines, a transmission flange nut for this transmission has higher torque requirements as compared to a transmission flange nut for a typical five-speed transmission. By way of example, this flange nut generally requires about 31.5 kgf·m of torque, whereas previous flange nuts only required about 18 kgf·m of torque. To apply the increased torque to the transmission flange nut 132, an exemplary torque modifier/multiplier 140 (FIGS. 2-7) is provided.

With reference now to FIGS. 2-7, the exemplary torque multiplier 140 for applying a predetermined torque to the shaft 130 via the transmission flange nut 130 of the vehicle engine comprises a support member 142 for mounting the torque multiplier 140 directly to the transmission case of a vehicle engine. The support member 142 includes a body 144 which can be appropriately shaped to the portion 100 of the transmission case 102. In the depicted embodiment, the body 144 includes a first end portion 146, a second end portion 148 opposite the first end portion, and opposed sides 150, 152 which at least partially converge at the first end portion 146. The body 144 can be substantially plate-shaped having a first surface 156 and a second surface 158 opposite the first surface 156.

In the illustrated embodiment, at least two fastening members 160, 162 are associated with the support member 142 and are directly secured to the transmission case 102. However, it should be appreciated that a single fastening member can be used to secure the support member 142 to the transmission case 102. The fastening members 160, 162 allow the torque multiplier 140 to be mounted directly to the transmission case 102, thereby eliminating the need to use two hands to simultaneously hold a torque wrench (such as torque wrench 310) and a separate multiplier reaction handle. The fastening members 160, 162 can be located at the second end portion 148 of the body 144; although, this is not required. According to one aspect, fastening member 160 includes an elongated shaft 164 having a first end portion 166 and a second threaded end portion 168. A gripping member 170 is mounted on the first end portion 166 of the shaft 164 which allows for easy rotation of the fastening member 160 by a user. As shown, the gripping member 170 can be a shaft 172 extending through a bore 174 provided in the first end portion 166 of the shaft 164. Fastening member 162 can have a configuration similar to fastening member 160 and includes an elongated shaft 184 having a first end portion 186, a second threaded end portion 168 and a gripping member 190. As will be described below, the threaded end portions 168, 188 of the respective fastening members 160, 162 threadingly engage corresponding openings, such as openings 114, provided on the transmission case 102. Therefore, it should be appreciated that the location of each of the fastening members 160, 162 on the support member 142 is dependent on the location of the corresponding openings 114 of the transmission case 102. It should also be appreciated that alternative configurations for the fastening members 160, 162 are contemplated. For example, each fastening member 160, 162 can include a flange provided at its second end portion having an opening for receiving one of the existing bolts 112 of the transmission case 102.

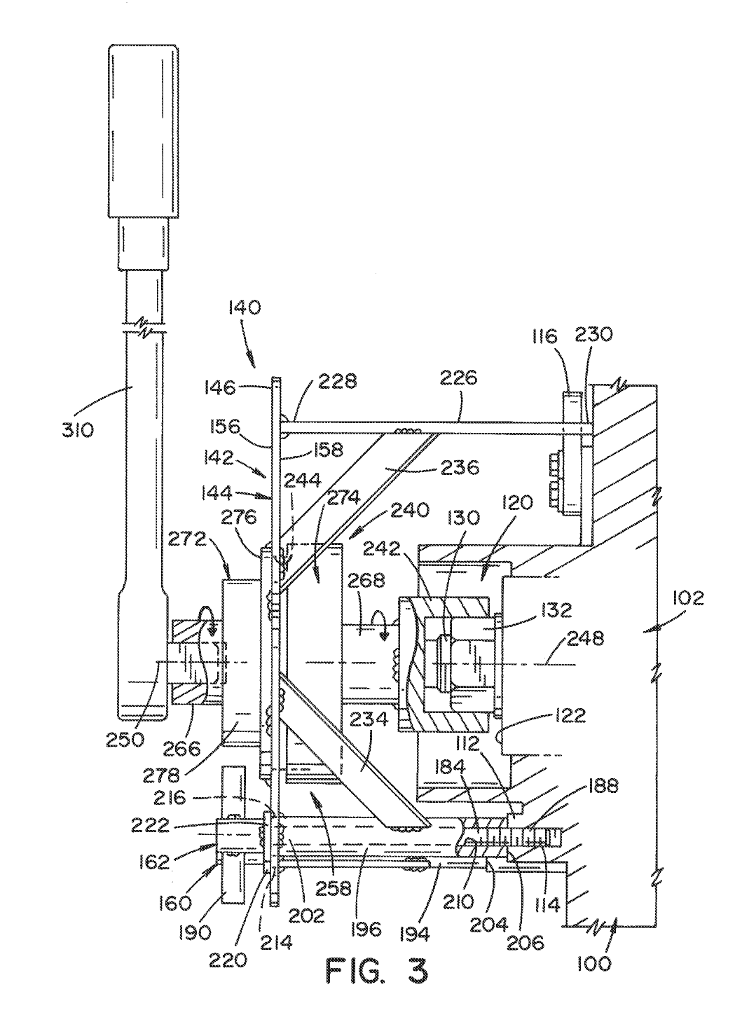

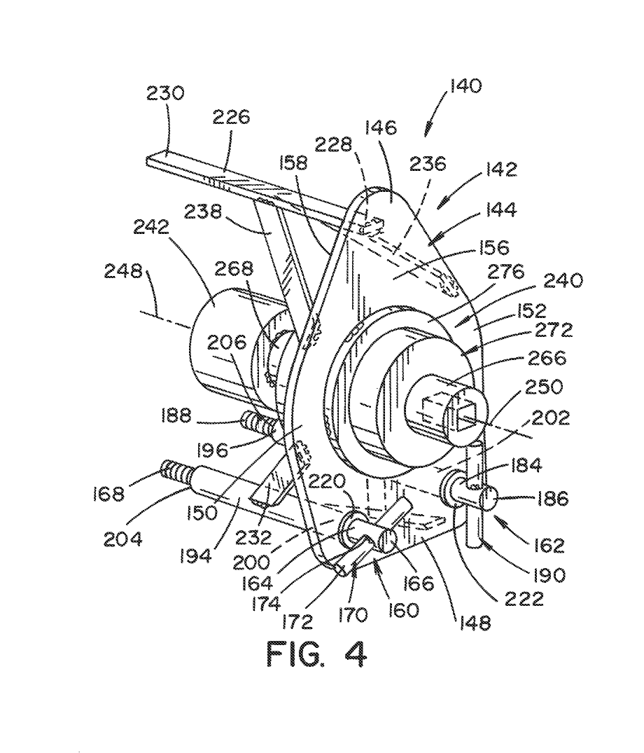

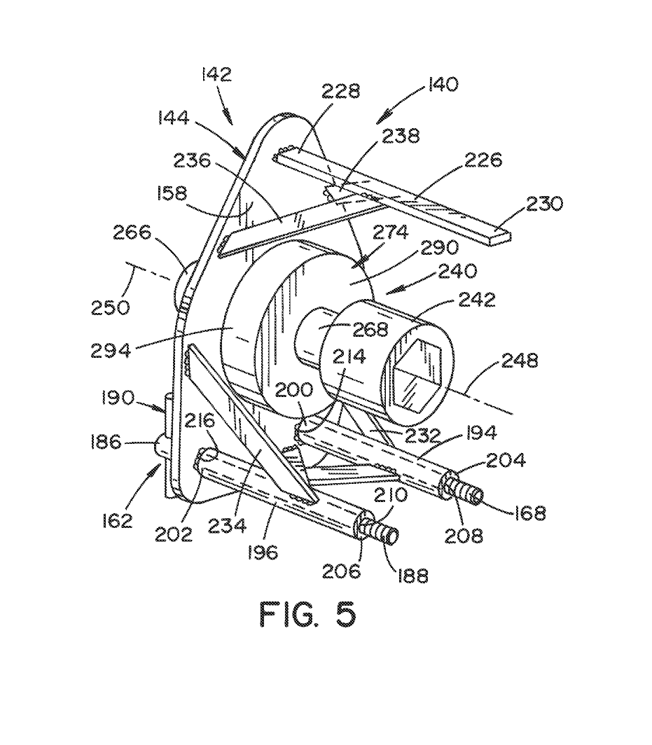

As best depicted in FIGS. 4 and 5, to secure the at least two fastening members 160, 162 to the torque multiplier 140, the support member 142 includes at least two spaced, parallel legs (i.e., a first leg 194 and a second leg 196) extending outwardly from the body 144 for mounting the torque multiplier 140 directly to the transmission case 102. Each leg 194, 196 includes a respective proximal end portion 200, 202 and a respective distal end portion 204, 206. Each leg 194, 196 further has a respective elongated bore 208, 210 which extends axially through the leg. The bores 208, 210 receive the fastening members 160, 162, and a length of each leg 194, 196 is shorter than a length of each elongated shaft 164, 184 of the fastening members 160, 162. This allows the threaded second end portions 168, 188 to project outwardly from the first and second legs 194, 196 a predetermined distance so that in the mounted condition of the torque multiplier 140, the distal end portion 204, 206 of each leg 194, 194 abuts the transmission case 102 (FIG. 3). To secure the first and second legs 194, 196 to the body 144 of the support member 142, the second end portion 148 of the body 144 is provided with openings 214, 216 dimensioned to receive the proximal end portions 200, 202 of the legs (FIG. 3). The proximal end portions 200, 202 can be provided with respective annular flanges 220, 222 that abut the first surface 156 of the body 144 thereby preventing the first and second legs 194, 196 from falling through the openings 214, 216. Once positioned in the openings 214, 216, the legs 194, 196 can be fixedly attached (i.e., welded) to the body 144.

The support member 142 of the exemplary torque multiplier 140 can further include a third leg 226 located at the first end portion 146 of the body 144 and extending outwardly from the body. In the depicted embodiment, a length of the third leg 226 is greater than the length of each of the first and second legs 194, 196. The third leg 226 includes a proximal end portion 228 and a distal end portion 230. The proximal end portion can be fixedly attached (e.g., by welding) to the second surface 158 of the body 144. In a mounted condition of the torque multiplier 140, the distal end portion 230 of the third leg 226 is received in a corresponding recess located on the transmission case 102, such a recess located adjacent the mounting bracket 116 (FIG. 3). It should also be appreciated that the distal end portion 230 can be received in the aperture 118 provided on the mounting bracket 116.

Strengthening members associated with the legs 194, 196, 226 can be provided on the support member 142 for providing rigidity to the torque multiplier 140. For example, strengthening member 232 has one end fixed to the body 144 and the other end fixed to the first leg 194. Strengthening member 234 has one end fixed to the body 144 and the other end fixed to the second leg 196. And strengthening members 236, 238 have one end fixed to the body 144 and the other end fixed to the third leg 226. It should also be appreciated that additional strengthening members can be provided on the torque multiplier 140.

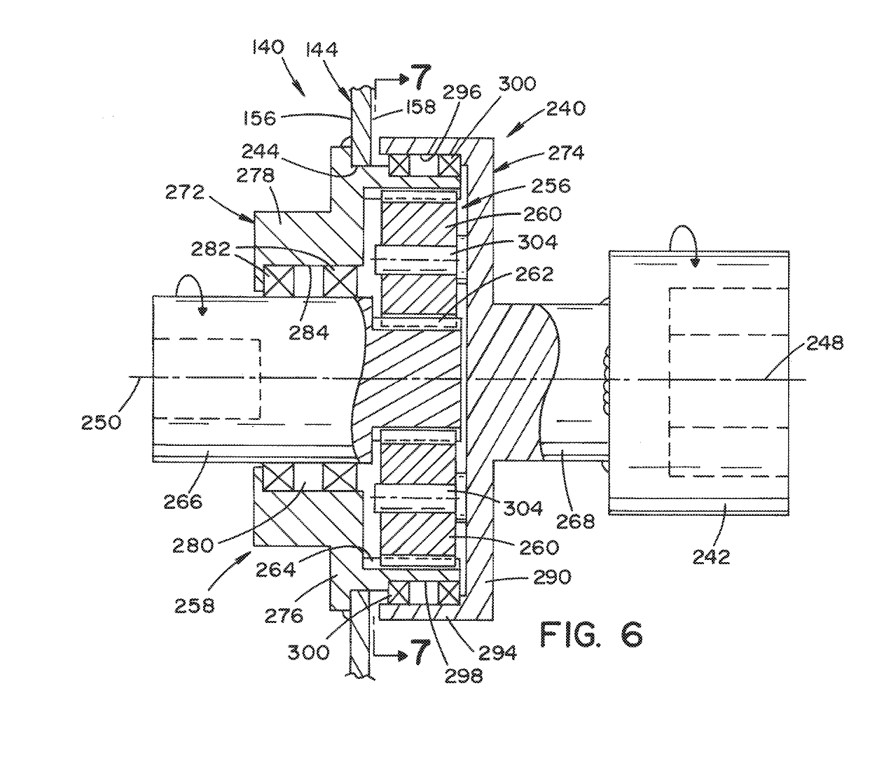

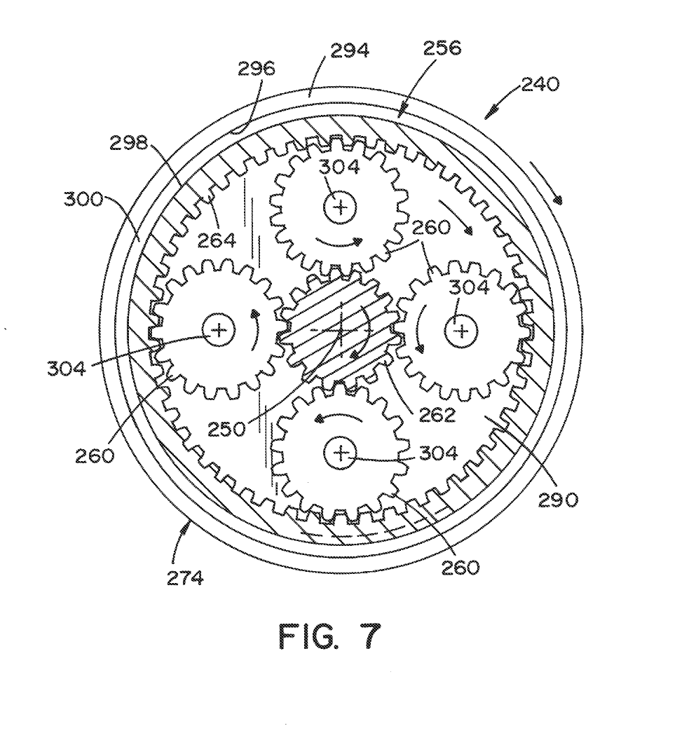

With reference now to FIGS. 6 and 7, the torque multiplier 140 further comprises a gear train 240 which is secured to the body 144 of the support member 142. A socket 242 is operably connected to the gear train 240 and engages the transmission flange nut 132. The socket 242 can be offset inwardly toward the body 144 relative to the distal end portion 204, 206 of each respective leg 194, 196. To secure the gear train 240 to the body 144 of the support member 142, the body includes an aperture 244 extending therethrough. The aperture 244 can be centrally located on the body 144; although, this is not required. Again, the location of the aperture 244 is dependent on the location of the transmission flange nut 132. The gear train 240 is at least partially positioned in the aperture 244 such that a center axis 248 of the socket 242 is collinear with a center axis 250 of the aperture 244. In the depicted embodiment, the gear train 240 is a planetary gear train 256 housed in a housing assembly 260 mounted to the body 144. The planetary gear train 256 includes at least one planet gear 260 which meshes with a sun gear 262 and an outer ring gear 264 which meshes with the at least one planet gear. According to one aspect, the at least one planet gear 260 is a plurality of planet gears 260 circumferentially spaced and revolving about the sun gear 262. The sun gear 262 is fixed to an end portion of an input 266 of the planetary gear train 256 and the socket 242 is directly mounted to an output 268 of the planetary gear train.

The housing assembly 260 can include a first housing part 272 positioned on the first surface 156 of the body 144 and a second housing part 274 positioned on the second surface 158 of the body 144. As shown, the first housing part 262 includes a base 276 fixed to the body 144 and a hub 278 extending outwardly from the base 276 (and the first surface 156). The hub 278 define a bore 280 dimensioned to receive the end portion of the input 266. Bearings 282 are positioned between an inner wall 284 of the hub 278 and an outer surface of the input 266 which allows the input to rotate relative to the fixed first housing part 272. The ring gear 264 is attached to the base 276 and extends at least partially through the aperture 244. As shown in FIG. 6, the ring gear 264 is integrally formed with the base 276 of first housing part 272, and, as such, is fixed with respect to rotation of the input 266. The second housing part 274 includes a base 290 having an annular wall 294 extending outwardly from the base 290 toward the second surface 158 of the body 144. An inner surface 296 of the annular wall 294 is spaced from an outer wall 298 of the ring gear 264 via bearings 300. The bearings 300 allow for rotation of the second housing part 272 relative to the fixed first housing part 270. The output 268 is attached to the base 290, and, according to one aspect, is integrally formed with the base 290. As indicated previously, the planet gears 260 revolve about the sun gear 262. To this end, each planet gear 260 is mounted to the second housing part 272 via a pin 304 secured to the base 290 of the second housing part.

With reference back to FIGS. 2 and 3, a ratchet-type torque wrench 310 is operably connected to the input 266 whereby the rate of rotation of the torque wrench 310 is reduced at the output 268 but the torque available at the socket 242 is increased approximately proportional to the gear ratio of the gear train 240. In operation, rotation of the torque wrench 310 rotates the input 266, and in turn, the sun gear 262 connected thereto, in a first direction. Rotation of the sun gear 262 causes each of the planet gears 260 to rotate in a second direction about an axis defined by each of the pins 304. With the ring gear 264 being fixed, the planet gears 260 revolve about the sun gear 262. As stated above, each of the planet gears 260 is fixed to the base 290 of the second housing part 272 via the pins 304. Thus, revolution of the planet gears 260 about the sun gear 262 rotates the second housing part, and in turn, the output 268 and the socket 242 connected thereto, in the first direction.

As is evident from the foregoing, the present disclosure further provides a method of applying a predetermined torque to a transmission shaft 130 via a transmission flange nut 132 of a vehicle engine. The method comprises mounting a torque multiplier 140 directly to a transmission case 102 of the vehicle engine; engaging the transmission flange nut 132 with a socket 242 of the torque multiplier 140; and applying torque to an input 266 of a planetary gear train 256. The mounting step includes threadingly engaging a corresponding opening 114 located on the transmission case 102 with a threaded portion 168, 188 of a fastening member 160, 162. The method includes inserting the fastening member 160, 162 through a elongated bore 208, 210 of a leg 194, 196 provided on a support member 142 of the torque multiplier 140. The method further includes inserting a distal end portion 230 of another leg 226 in a corresponding recess located on the transmission case 102.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A torque multiplier for applying a predetermined torque to a transmission flange nut of a vehicle engine comprises:
a support member for mounting the torque multiplier directly to a transmission case of a vehicle engine;
a gear train secured to the body; and
a socket operably connected to the gear train, the socket engaging a transmission flange nut.

2. The torque multiplier of claim 1, further including at least two fastening members associated with the support member, each fastening member being secured to the transmission case.

3. The torque multiplier of claim 2, wherein each fastening member includes a threaded portion for threadingly engaging a corresponding opening provided on the transmission case.

4. The torque multiplier of claim 3, wherein the support member includes a body and at least two spaced, parallel legs extending outwardly from the body, a distal end portion of each leg abutting the transmission case.

5. The torque multiplier of claim 4, wherein each leg includes an elongated bore for receiving one of the fastening members.

6. The torque multiplier of claim 4, wherein the socket is offset inwardly toward the body relative to the distal end portion of each leg.

7. The torque multiplier of claim 4, where the at least two legs includes a first leg, a second leg and a third leg, each leg extending outwardly from the body, the first and second legs including the elongated bores for receiving the fastening members.

8. The torque multiplier of claim 7, wherein a length of the third leg is greater than a length of each of the first and second legs, a distal end portion of the third leg being received in a corresponding recess located on the transmission case.

9. The torque multiplier of claim 1, wherein the support member includes an aperture extending therethrough, the gear train being at least partially positioned in the aperture, and a center axis of the socket is collinear with a center axis of the aperture.

10. The torque multiplier of claim 9, wherein the gear train is a planetary gear train including at least one planet gear revolving around a sun gear and a ring gear, the ring gear being fixed in the aperture, the socket being directly mounted to an output of the planetary gear train.

11. The torque multiplier of claim 10, wherein the gear train is housed in a housing assembly mounted to the support member, the housing assembly including a first fixed housing part and a second rotatable housing part.

12. A torque multiplier for applying a predetermined torque to a transmission flange nut of a vehicle engine comprises:
a support member including first and second legs for mounting the torque multiplier directly to a transmission case of a vehicle engine;
a planetary gear train secured to the support member; and
a socket operably directly connected to an output of the planetary gear train, the socket engaging a transmission flange nut.

13. The torque multiplier of claim 12, wherein each of the first and second legs includes an elongated bore, and further including a pair of fastening members, each fastening member including a threaded portion for threadingly engaging a corresponding opening provided on the transmission case, each threaded portion being received in one of the elongated bores of the first and second legs.

14. The torque multiplier of claim 12, wherein the support member includes a body having a centrally located aperture extending therethrough, the planetary gear train being at least partially positioned in the aperture and mounted to the body.

15. The torque multiplier of claim 14, wherein the planetary gear train includes at least two planet gears, a sun gear and a ring gear, the ring gear being fixed in the aperture.

16. The torque multiplier of claim 12, wherein the support member includes a plate-shaped body having a first end portion and a second end portion opposite the first end portion, the first and second legs being located at the first end portion, and further including a third leg located at the second end portion.

17. A method of applying a predetermined torque to a transmission flange nut of a vehicle engine comprising:
mounting a torque multiplier directly to a transmission case of the vehicle engine, the torque multiplier including:
a support member having an aperture,
a planetary gear train secured in the aperture and having an input and an output; and
a socket operably connected to the output of the planetary gear train;
engaging the transmission flange nut with the socket; and
applying torque to the input of the planetary gear train.

18. The method of claim 17, wherein the torque multiplier further includes a fastening member having a threaded portion, and the mounting step includes threadingly engaging a corresponding opening located on the transmission case with the threaded portion of the fastening member.

19. The method of claim 18, wherein the support member of the torque multiplier includes a body and a first leg extending outwardly from the body, the first leg having an elongated bore, and the method includes inserting the fastening member through the elongated bore of the first leg.

20. The method of claim 19, wherein the torque multiplier further includes a second leg extending outwardly from the body, the second leg having a length greater than a length of the first leg, and the method includes inserting a distal end portion of the second leg in a corresponding recess located on the transmission case.
